(19) United States
(12) Patent Application Publication
(10) Pub. No.: US 2026/0049506 A1
(43) Pub. Date: Feb. 19, 2026

(54) DOOR LATCH DEVICE

(71) Applicant: Mitsui Kinzoku Act Corporation, Yokohama-shi (JP)

(72) Inventor: Keiichiro OKUYAMA, Kanagawa (JP)

(73) Assignee: Mitsui Kinzoku Act Corporation, Yokohama-shi (JP)

(21) Appl. No.: 19/301,889

(22) Filed: Aug. 15, 2025

(30) Foreign Application Priority Data
Aug. 19, 2024 (JP) 2024-137749

(51) Int. Cl. E05B 81/90; E05B 81/06; E05B 81/14; E05B 81/30; E05B 81/56; E05B 81/86

(52) U.S. Cl. CPC E05B 81/90; E05B 81/06; E05B 81/14; E05B 81/30; E05B 81/56; E05B 81/86

(57) ABSTRACT

A door latch device is to be attached to a door of a vehicle. The door latch device has a latch mechanism maintaining the door in a closed state, an electric release mechanism canceling a latched state by driving a motor, and a manual release mechanism canceling the latched state by a manual operation. The electric release mechanism includes an electric release lever operated by driving the motor. The electric release lever includes a first lever operated by driving the motor, and a second lever engaged with the latch mechanism. The manual release mechanism includes an inner lever operated by manually operating a vehicle interior operation portion provided inside a vehicle cabin. The door latch device further has a cancellation mechanism canceling a coupled state between the first lever and the second lever by an operation force of the vehicle interior operation portion.

### CROSS-REFERENCE TO RELATED APPLICATIONS

This application is based on and claims priority under 35 USC 119 from Japanese Patent Application No. 2024-137749 filed on Aug. 19, 2024, the entire content of which is incorporated herein by reference.

### TECHNICAL FIELD

The present disclosure relates to a door latch device to be attached to a door of a vehicle.

### BACKGROUND ART

This section provides background information related to door latch devices and is not necessarily prior art to the door latch device of the present disclosure.

In a door latch device to be attached to a door of a vehicle, an electrical door latch device (also called an E latch) capable of releasing engagement between a latch mechanism and a striker by a driving force of a motor is known. In addition to an electrical disengagement mechanism, the electric door latch device is provided with a mechanical disengagement mechanism capable of releasing the engagement between the latch mechanism and the striker by a manual operation of a handle or the like, as a countermeasure in case the motor becomes unable to be driven due to power interruption or the like (for example, JP7385435B, JP4617588B, and JP7035709B).

In the electrical door latch device, if the motor becomes unable to be driven after the electrical disengagement mechanism operates the latch mechanism from a latched state to an unlatched state, the latch mechanism may be maintained in a state where the latch mechanism cannot be locked to the striker (also referred to as a latch disabled state), and the door may not be able to close.

The door lock device described in JP7035709B is provided with a cancellation mechanism as a countermeasure against a case of the latch disabled state. When the door inner handle is operated, the active lever rotates to release coupling between a release lever and a cancellation lever coupled by a cancel pin, and the door can be changed from an open state to a closed state.

### SUMMARY OF INVENTION

The present disclosure provides a door latch device that enables to cancel a latch disabled state with good operability even if the latch disabled state occurs.

An aspect of the present disclosure relates to a door latch device to be attached to a door of a vehicle, the door latch device having:
a latch mechanism including a latch configured to be engaged with a striker provided on a vehicle body, and maintaining the door in a closed state with respect to the vehicle body by bringing the latch into a latched state where the latch is locked to the striker;
an electric release mechanism configured to cancel the latched state by driving a motor; and
a manual release mechanism configured to cancel the latched state by a manual operation, in which
the electric release mechanism includes an electric release lever operated by driving the motor,
the electric release lever includes:
   a first lever operated by driving the motor; and
   a second lever engaged with the latch mechanism in a coupled state of operating in conjunction with the first lever, to cancel the latched state,
the manual release mechanism includes an inner lever operated by manually operating a vehicle interior operation portion provided inside a vehicle cabin, and
the door latch device further has:
   a cancellation mechanism provided independently of the motor, and canceling the coupled state between the first lever and the second lever by an operation force of the vehicle interior operation portion transmitted via the inner lever, to allow the second lever to retract from a predetermined position.

According to the present disclosure, since the door latch device includes the cancellation mechanism that operates by the manual operation of the vehicle interior operation portion, even in a case where the motor becomes unable to be driven due to power shortage, failure, or the like and the latch disabled state is maintained, it is possible to cancel the latch disabled state by manually operating the vehicle interior operation portion. Therefore, since the door can be reliably closed even in an emergency, the antitheft performance is improved, and the reliability of the door latch device is improved. Since the cancellation mechanism is provided independently of the motor, the cancellation mechanism can operate without being affected by the stuck motor, and the latch disabled state can be released with good operability.

### BRIEF DESCRIPTION OF DRAWINGS

Exemplary embodiment(s) of the present invention will be described in detail based on the following figures, wherein:

FIG. 1 is a right side view of a vehicle V to which a door latch device 1 of an embodiment of the present disclosure is attached;

FIG. 2 is a perspective view of the door latch device 1 viewed from the rear and a vehicle inner side;

FIG. 3 is a perspective view of the door latch device 1 before a latch mechanism 20 is attached to a housing 11;

FIG. 4 is a perspective view of an electrical component 80 mounted on the door latch device 1;

FIG. 5 is a rear view of the latch mechanism 20;

FIG. 6 is a perspective view of the latch mechanism 20 (body 21 not illustrated) as viewed from a front side;

FIG. 7 is a rear view of a pawl lever 34 and an outer lever 71;

FIG. 8 is a view of an electric release mechanism 40, a manual release mechanism 60, and a cancellation mechanism 100 as viewed from the vehicle inner side;

FIG. 9 is an exploded perspective view of elements of the electric release mechanism 40, the manual release mechanism 60, and the cancellation mechanism 100;

FIG. 10 is a diagram illustrating the electric release mechanism 40 (left side) and the latch mechanism 20 (right side) in a standby position;

FIG. 11 is a diagram illustrating the electric release mechanism 40 (left side) and the latch mechanism 20 (right side) operated in a release direction;

FIG. 12 is a diagram illustrating the electric release mechanism 40 ((left side) and the latch mechanism 20 (right side) operated in a standby direction;

FIG. 13 is a diagram illustrating the manual release mechanism 60 (left side) and the latch mechanism 20 (right side) operated in the release direction;

FIG. 14 is a diagram illustrating the manual release mechanism 60 (left side) and the latch mechanism 20 (right side) operated in the standby direction;

FIG. 15 is a diagram (part 1) illustrating an operation of the cancellation mechanism 100 (left side) and the latch mechanism 20 (right side) when canceling a latch disabled state;

FIG. 16 is a diagram (part 2) illustrating the operation of the cancellation mechanism 100 (left side) and the latch mechanism 20 (right side) when canceling the latch disabled state; and

FIG. 17 is a diagram (part 3) illustrating the operation of the cancellation mechanism 100 (left side) and the latch mechanism 20 (right side) when canceling the latch disabled state.

### DESCRIPTION OF EMBODIMENTS

Hereinafter, a door latch device of an embodiment of the present disclosure will be described in detail with reference to the accompanying drawings. The drawings are to be viewed in directions of reference signs. The door latch device exemplified here is a vehicle door latch device mounted on left and right doors (including a front door and a rear door) of an automobile. In the drawings, the front of a vehicle is denoted by Fr, the rear is denoted by Rr, an upper side is denoted by U, and a lower side is denoted by D. A vehicle inner side in a left-right direction (vehicle width direction) is denoted by IN, and a vehicle outer side is denoted by OUT. The front, rear, vehicle inner side, and vehicle outer side in the description are directions based on a fully-closed state where the doors are completely closed.

### [Overall Configuration of Door Latch Device]

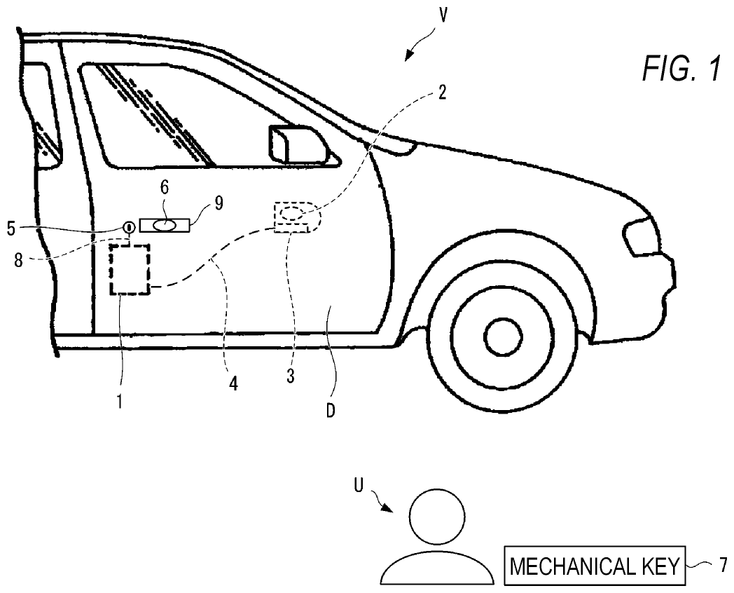

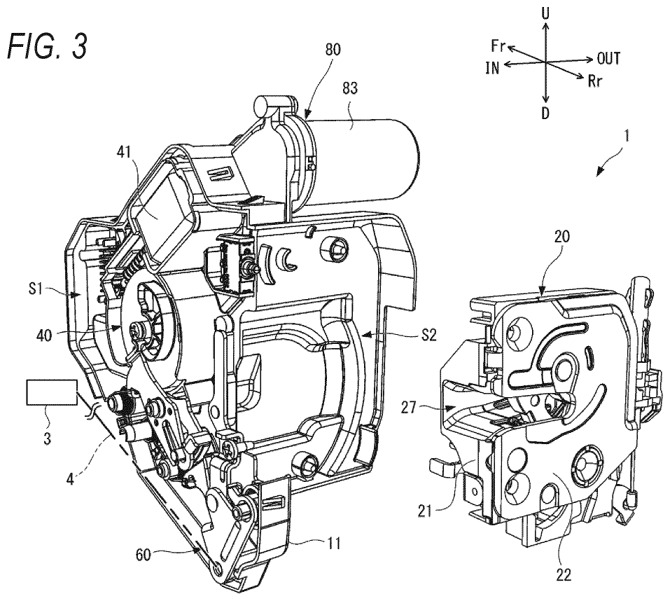

FIG. 1 is a side view of a vehicle V to which a door latch device 1 of an embodiment of the present disclosure is attached. The door latch device 1 is attached to, for example, a rear end inside a right door D of the vehicle V. The door latch device 1 is an electrical door latch device capable of performing an opening operation of the door D by a motor 41 (see FIG. 3 and the like) driven by an operation of a vehicle cabin interior switch 2 provided inside a vehicle cabin or a vehicle cabin exterior switch 6 provided on an outside handle 9 outside the vehicle cabin, and is also called an E latch.

The door latch device 1 can perform the opening operation of the door D not only by the electrical opening operation using the motor 41 but also by a manual operation of a user U. Specifically, the opening operation of the door D can also be performed by a physical operation such as an operation of an inner handle 3 (an example of a vehicle interior operation portion) provided inside the vehicle cabin or an operation using a mechanical key 7 with respect to a key cylinder 5 (an example of a vehicle exterior operation portion) provided outside the vehicle cabin. The opening operation of the door D by the inner handle 3 or the mechanical key 7 is basically performed in an emergency such as power shortage or failure of the motor 41, and the normal opening operation of the door D is electrically performed by the vehicle cabin interior switch 2 or the vehicle cabin exterior switch 6.

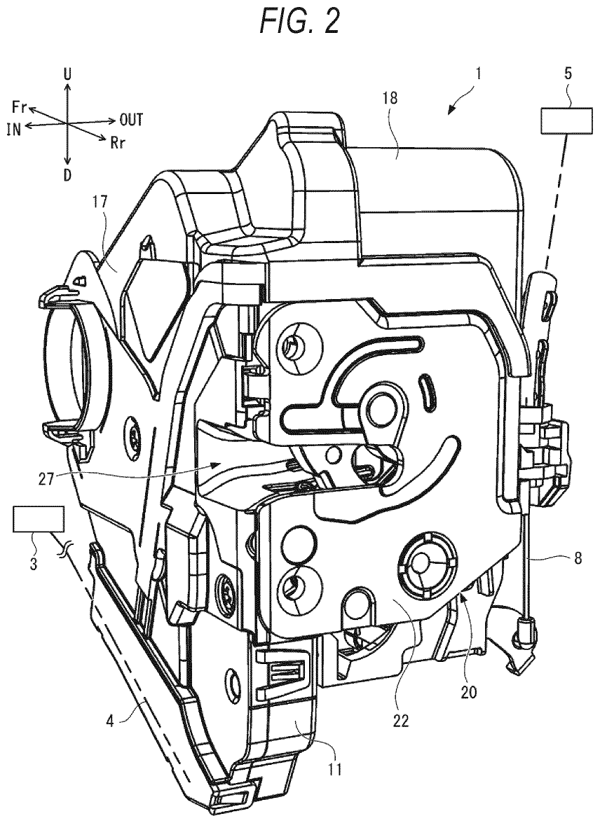

As illustrated in FIGS. 2 and 3, the door latch device 1 includes a housing 11 made of a synthetic resin or the like, a latch mechanism 20 that maintains the door D in a closed state with respect to a vehicle body, an electric release mechanism 40 that electrically opens the door D by driving the motor 41, and a manual release mechanism 60 that mechanically opens the door D by a manual operation from a vehicle cabin interior side and a vehicle cabin exterior side. The electric release mechanism 40 and the manual release mechanism 60 are disposed in a space S1 provided on the vehicle inner side of the housing 11, and are accommodated in the housing 11 by being covered with a first cover 17 attached from the vehicle inner side. A latch mechanism 20 is assembled to a space S2 provided on a rear side of the housing 11.

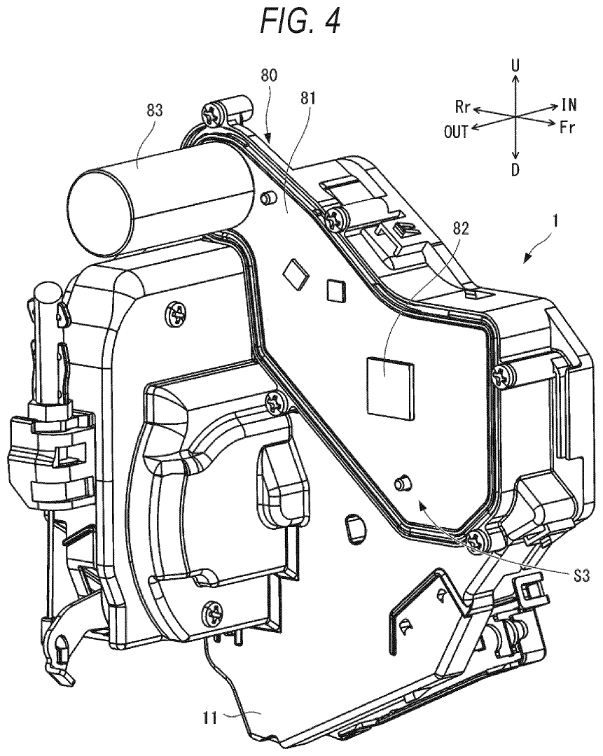

As illustrated in FIGS. 3 and 4, the door latch device 1 further includes an electrical component 80 that operates the electric release mechanism 40. The electrical component 80 includes, for example, a circuit board 81, an electronic control unit (ECU) 82 that is mounted on the circuit board 81 and controls the driving of the motor 41, and a capacitor 83 such as a capacitor that stores power to be supplied to the motor 41 and the ECU 82. The electrical component 80 is disposed in a space S3 provided on an upper side and the vehicle outer side of the housing 11, and is accommodated in the housing 11 by being covered with a second cover 18 attached from above and a third cover (not illustrated) attached from the vehicle outer side.

The motor 41, the ECU 82, and the capacitor 83 are disposed in an upper portion of the door latch device 1, specifically, above a striker entering groove 27 to be described later, thereby preventing the motor 41, the ECU 82, and the capacitor 83 from being exposed to liquids such as rainwater entering from the striker entering groove 27.

### [Latch Mechanism]

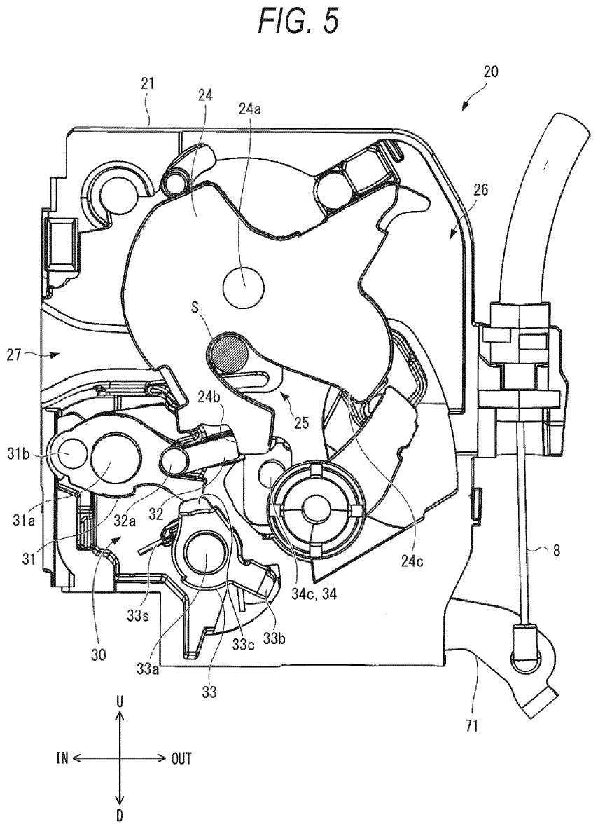

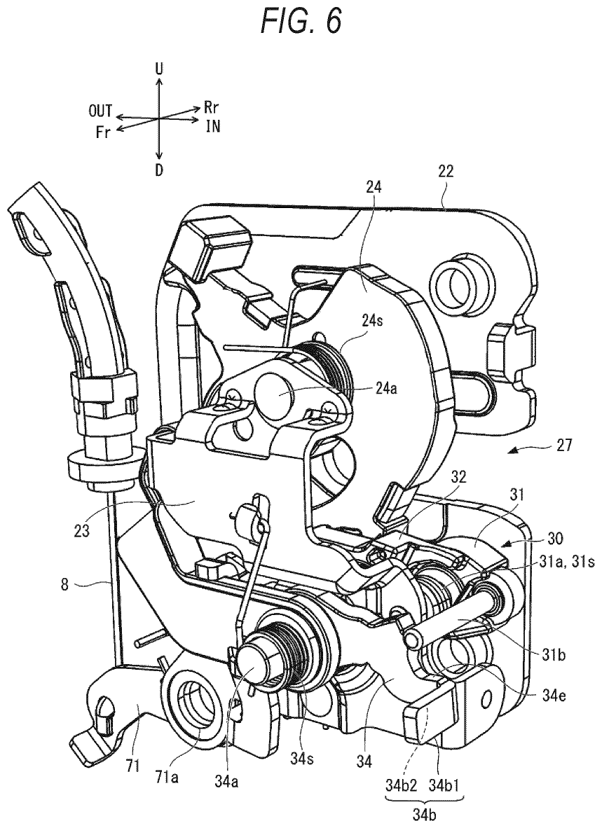

FIG. 5 is a rear view of the latch mechanism 20 as viewed from a rear side, and FIG. 6 is a perspective view of the latch mechanism 20 (body 21 not illustrated) as viewed from a front side. FIGS. 5 and 6 illustrate a state where the latch mechanism 20 is engaged with a striker S provided on the vehicle body.

The latch mechanism 20 includes the body 21 made of a synthetic resin or the like, a metal cover plate 22 disposed on a rear side of the body 21, a metal back plate 23 disposed on a front side of the body 21, a latch 24 that is rotatable around a latch shaft 24a and can be engaged with the striker S provided on the vehicle body when the door D is closed, and a pawl mechanism 30 including a pawl 32 that can be engaged with the latch 24. The latch 24 and the pawl mechanism 30 are supported by the body 21, the cover plate 22, and the back plate 23.

A recessed accommodating portion 26 that accommodates the latch 24 and a part of the pawl mechanism 30 is provided on a rear surface side of the body 21. The cover plate 22 is fixed in the door D by bolts (not illustrated), and is disposed so as to cover the accommodating portion 26 of the body 21. The back plate 23 supports the latch 24, the pawl mechanism 30, and an outer lever 71 to be described later from the front side of the body 21.

The body 21 and the cover plate 22 are provided with a striker entering groove 27 at a substantially central portion in an up-down direction. The striker entering groove 27 is a portion into which the striker S enters when the door is closed, extends in the vehicle width direction, and opens to the vehicle inner side. The latch 24 is provided above the striker entering groove 27, and the pawl mechanism 30 is provided below the striker entering groove 27.

The latch 24 has an accommodating groove 25 that is recessed from an outer peripheral surface toward the latch shaft 24a and capable of accommodating the striker S. A coil spring 24s is wound around the latch shaft 24a, and the latch 24 is biased in a direction in which the latch 24 is disengaged from the striker S by a biasing force of the coil spring 24s to open the door D, specifically, in a clockwise direction in FIG. 5.

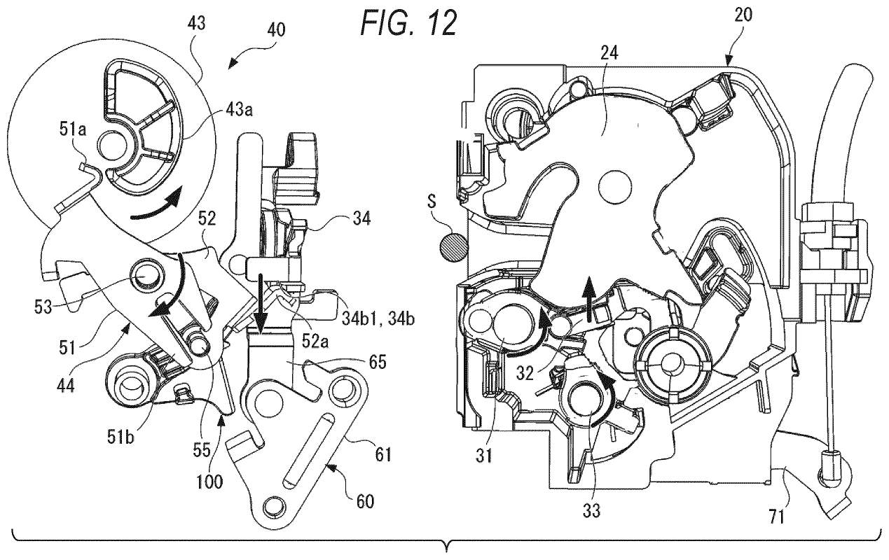

A full-latch engagement portion 24b and a half-latch engagement portion 24c are provided on the outer peripheral surface of the latch 24. When the pawl 32 is engaged with the full-latch engagement portion 24b, the latch 24 is in a full-latched state (see FIG. 5) corresponding to a state where the door D is completely closed. When the pawl 32 is engaged with the half-latch engagement portion 24c, the latch 24 is in a half-latched state (not illustrated) corresponding to a half-door state. The full-latched state and the half-latched state are states in which the latch 24 is locked to the striker S by the pawl 32, and are collectively referred to as a latched state. When the latch 24 is not engaged with the striker S and is not locked to the striker S by the pawl 32, the latch 24 is in an unlatched state (see FIG. 12 and the like) corresponding to a fully opened state where the door D is completely opened.

When the latch 24 is engaged with the striker S, the pawl mechanism 30 maintains the latched state where the latch 24 is locked to the striker S. The pawl mechanism 30 includes a ratchet 31 rotatable around a ratchet shaft 31a, the pawl 32 provided at an end of the ratchet 31 and capable of being engaged with the latch 24, a retaining lever 33 rotatable around a lever shaft 33a, and a pawl lever 34 that transmits a driving force of the motor 41 or an operation force by a manual operation to the pawl 32 to cancel the latched state. In the following description of operation directions of each element of the pawl mechanism 30, the direction in which the pawl 32 is engaged with the latch 24 is also referred to as an “engagement direction”, and the direction in which the pawl 32 is separated and disengaged from the latch 24 is also referred to as a “release direction”.

The ratchet 31, the pawl 32, and the retaining lever 33 are accommodated in the accommodating portion 26 of the body 21, and the pawl lever 34 is disposed in front of the back plate 23.

The ratchet 31 is rotatably supported around the ratchet shaft 31a. The ratchet 31 is biased in the engagement direction (counterclockwise direction in FIG. 5) by a biasing force of a coil spring 31s wound around the ratchet shaft 31a. The ratchet 31 includes an input portion 31b that extends in a front-rear direction and with which the pawl lever 34 can be engaged from below. The input portion 31b receives an input of the driving force of the motor 41 or an operation force by a manual operation via the pawl lever 34.

The pawl 32 is rotatable around a pawl shaft 32a that is inserted through a shaft hole provided at the end of the ratchet 31. The pawl 32 is biased in the engagement direction to be engaged with the latch 24, specifically, in the counterclockwise direction in FIG. 5, by a biasing force of a coil spring (not illustrated) hooked on the ratchet 31, and normally abuts against the outer peripheral surface of the latch 24. When the ratchet 31 rotates in the release direction (clockwise direction in FIG. 5), the pawl 32 rotates in the release direction together with the ratchet 31 against the biasing force of the coil spring.

The retaining lever 33 is provided below the ratchet 31 and is rotatable around the lever shaft 33a. The retaining lever 33 includes an input portion 33b that can be engaged with the pawl lever 34 and receives an input of the driving force of the motor 41 or an operation force by a manual operation via the pawl lever 34, and a retaining portion 33c that abuts against the ratchet 31 from below to prevent the ratchet 31 from rotating in the release direction. The retaining lever 33 is biased in a direction (counterclockwise direction in FIG. 5) in which the retaining portion 33c is engaged with the ratchet 31 by a biasing force of a coil spring 33s wound around the lever shaft 33a. The retaining lever 33 normally abuts against the ratchet 31 from below to prevent the ratchet 31 from rotating in the release direction. On the other hand, when the retaining lever 33 rotates in the release direction (clockwise direction in FIG. 5) by the input received by the input portion 33b, the retaining lever 33 is disengaged from the ratchet 31, allowing the ratchet 31 to rotate in the release direction.

The pawl lever 34 can be engaged with the electric release mechanism 40 and the manual release mechanism 60, and is rotatable around the lever shaft 34a. The pawl lever 34 is biased in the counterclockwise direction in FIG. 5 by a biasing force of a coil spring 34s wound around the lever shaft 34a.

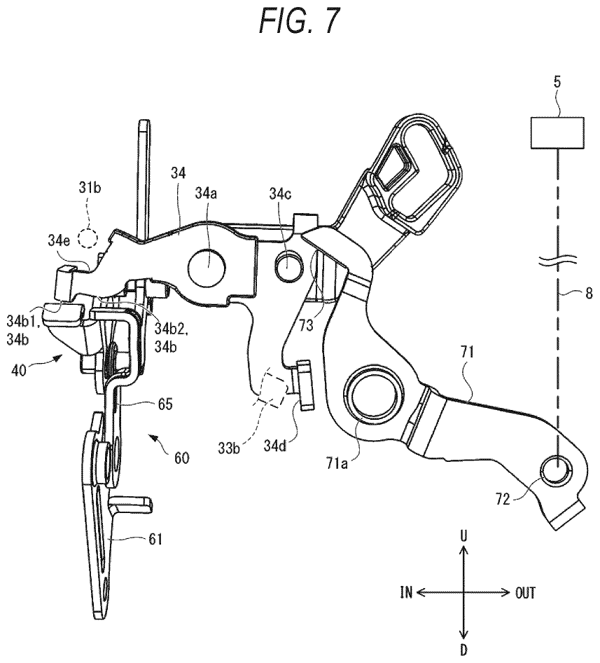

Referring to FIG. 7, the pawl lever 34 includes a first input portion 34b that receives an input of the driving force of the motor 41 and an operation force of the inner handle 3, a second input portion 34c that receives an input of an operation force of the key cylinder 5 provided outside the vehicle, a retaining lever operation portion 34d that can be engaged with the input portion 33b of the retaining lever 33 and rotates the retaining lever 33, and a ratchet operation portion 34e that can be engaged with the input portion 31b of the ratchet 31 and rotates the ratchet 31. The first input portion 34b is provided on the vehicle inner side of the lever shaft 34a, and the second input portion 34c is provided on the vehicle outer side of the lever shaft 34a.

The first input portion 34b of the pawl lever 34 includes an electric side engagement portion 34b 1 that is engaged with the electric release mechanism 40 and receives an input of the driving force of the motor 41, and a manual side engagement portion 34b2 that is engaged with the manual release mechanism 60 and receives an input of the operation force of the inner handle 3. The electric side engagement portion 34b1 and the manual side engagement portion 34b2 are provided at different positions.

When the latch 24 is in the latched state and there is a driving force of the motor 41 or an operation force of the inner handle 3, the first input portion 34b is pushed up by the electric release mechanism 40 or the manual release mechanism 60, and the pawl lever 34 rotates around the lever shaft 34a. Accordingly, the retaining lever operation portion 34d is engaged with the input portion 33b of the retaining lever 33, and rotates the retaining lever 33 in the release direction against the biasing force of the coil spring 33s. Subsequently, the ratchet operation portion 34e is engaged with the input portion 31b of the ratchet 31, rotates the ratchet 31 in the release direction against the biasing force of the coil spring 31s, and also rotates the pawl 32 provided in the ratchet 31 in the release direction. Accordingly, the pawl 32 is separated from the latch 24 and is in the non-engaged state (non-abutment state), the latched state is released, and the door D is opened.

The latch mechanism 20 is provided with the outer lever 71 supported by the back plate 23 at a position on the vehicle outer side and a lower side. The outer lever 71 is rotatable about a lever shaft 71a. The outer lever 71 is biased in a direction away from the second input portion 34c of the pawl lever 34, specifically, in a clockwise direction in FIG. 7, by a biasing force of a coil spring (not illustrated) wound around the lever shaft 71a.

The outer lever 71 includes an input portion 72 that is connected to the key cylinder 5 via a cable 8 and receives an input of the operation force of the key cylinder 5, and an operation portion 73 that can be engaged with the second input portion 34c of the pawl lever 34 and rotates the pawl lever 34. The operation portion 73 is provided on the opposite side of the lever shaft 71a from the input portion 72.

When the key cylinder 5 is operated while the latch 24 is in the latched state, the input portion 72 of the outer lever 71 is pulled upward by the cable 8, and the outer lever 71 rotates around the lever shaft 71a. The operation portion 73 of the outer lever 71 is engaged with the second input portion 34c of the pawl lever 34 to press down the second input portion 34c. Accordingly, the pawl lever 34 rotates around the lever shaft 34a, the retaining lever operation portion 34d is engaged with the input portion 33b of the retaining lever 33, and rotates the retaining lever 33 in the release direction against the biasing force of the coil spring 33s. Subsequently, the ratchet operation portion 34e is engaged with the input portion 31b of the ratchet 31, rotates the ratchet 31 in the release direction against the biasing force of the coil spring 31s, and also rotates the pawl 32 provided in the ratchet 31 in the release direction. Accordingly, the pawl 32 is separated from the latch 24 and is in a non-engaged state (non-abutment state), the latched state is released, and the door D is opened.

### [Electric Release Mechanism]

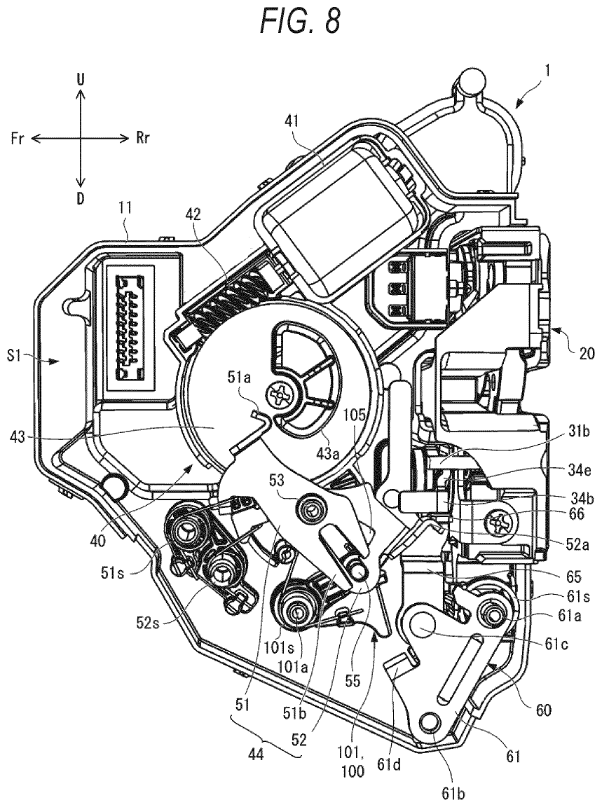

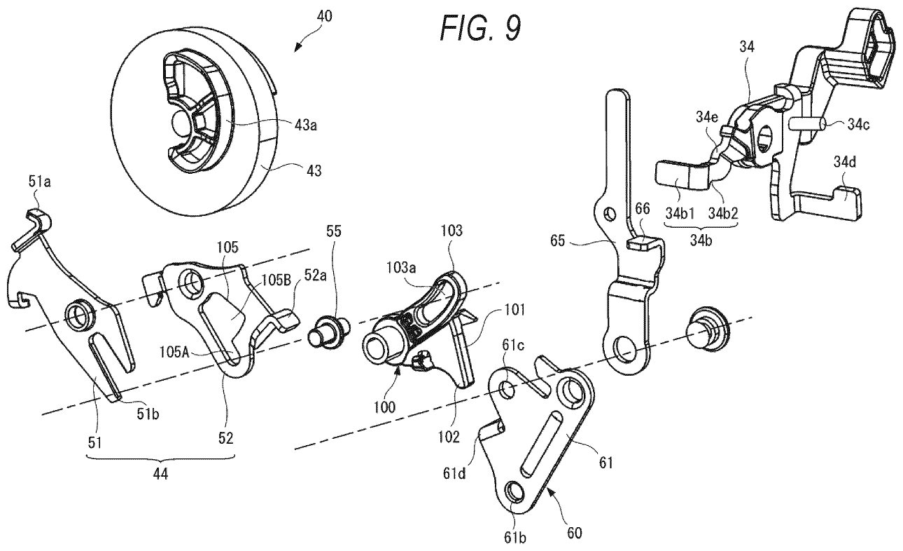

As illustrated in FIGS. 8 and 9, the electric release mechanism 40 includes the motor 41, a worm gear 42 provided on a drive shaft of the motor 41, a cam wheel 43 that meshes with the worm gear 42 via teeth formed on an outer peripheral surface thereof and has a cam portion 43a, and an electric release lever 44 that works by abutting against the cam portion 43a. The electric release mechanism 40 transmits the driving force of the motor 41 to the pawl lever 34 of the latch mechanism 20 via the worm gear 42, the cam wheel 43, and the electric release lever 44 to cancel the latched state. Each element of the electric release mechanism 40 illustrated in FIG. 8 is in a standby position.

The motor 41 is disposed such that the drive shaft provided with the worm gear 42 faces forward and downward. The motor 41 is driven based on an operation of the vehicle cabin interior switch 2 or the vehicle cabin exterior switch 6. For example, when a speed of the vehicle V is equal to or higher than a predetermined speed, the ECU 82 controls the motor 41 so as not to drive the motor 41 even if the vehicle cabin interior switch 2 or the vehicle cabin exterior switch 6 is operated.

The cam wheel 43 is rotatable around an axis extending in the vehicle width direction, and is disposed below the motor 41 and the worm gear 42. The cam portion 43a is provided on a surface of the cam wheel 43 on the vehicle inner side and protrudes toward the vehicle inner side. When the cam wheel 43 rotates in a clockwise direction in FIG. 8, a distance between the cam portion 43a and a center of the cam wheel 43 increases. In the following description, the rotation of the cam wheel 43 in the clockwise direction in FIG. 8 is also referred to as forward rotation, and the rotation in a counterclockwise direction is also referred to as reverse rotation. A direction in which the electric release lever 44 moves when the cam wheel 43 rotates forward from the standby position is also referred to as a release direction, and a direction in which the electric release lever 44 moves when the cam wheel 43 rotates reversely toward the standby position is also referred to as a standby direction.

The electric release lever 44 includes a first lever 51 that is operated by driving the motor 41, and a second lever 52 that is engaged with the latch mechanism 20 when in a coupled state of operating in conjunction with the first lever 51. Although details will be described later, the second lever 52 can be shifted between the coupled state where the second lever 52 operates in conjunction with the first lever 51 and a non-coupled state where the second lever 52 operates independently of the first lever 51.

The first lever 51 is rotatable around a lever shaft 53 provided below the cam wheel 43. The first lever 51 includes a cam abutment portion 51a that can abut against the cam portion 43a, and a coupling portion 51b coupled to the second lever 52. The cam abutment portion 51a and the coupling portion 51b are provided on opposite sides with the lever shaft 53 in between. The first lever 51 is disposed such that at least the cam abutment portion 51a overlaps the cam wheel 43 when viewed from an axial direction of the lever shaft 53. The first lever 51 is biased by a biasing force of a coil spring 51s provided in the housing 11 in a direction in which the first lever 51 abuts against the cam portion 43a, specifically, in the clockwise direction in FIG. 8.

The second lever 52 is rotatable around the lever shaft 53, that is, is rotatable coaxially with the first lever 51. The second lever 52 is disposed so as to at least partially overlap the first lever 51 when viewed from the axial direction of the lever shaft 53. The second lever 52 is disposed at a position not overlapping the cam wheel 43 when viewed from the axial direction of the lever shaft 53, and is not directly engaged with the cam wheel 43. The second lever 52 is disposed at a position closer to the pawl lever 34 of the latch mechanism 20 than the first lever 51, and includes, at a rear end thereof, an operation portion 52a that is engaged with the first input portion 34b (electric side engagement portion 34b1) of the pawl lever 34 to operate the pawl lever 34.

The second lever 52 is biased in a direction away from the pawl lever 34 of the latch mechanism 20, specifically, in the clockwise direction in FIG. 8, by a biasing force of a coil spring 52s provided in the housing 11. In a case where the first lever 51 and the second lever 52 are in the coupled state, when the motor 41 rotates forward, the second lever 52 rotates in the counterclockwise direction around the lever shaft 53 against the biasing force of the coil spring 52s, and the operation portion 52a is engaged with the first input portion 34b (electric side engagement portion 34b1) of the pawl lever 34 from below to push up the first input portion 34b.

The second lever 52 can be shifted between the coupled state where the second lever 52 is coupled to the first lever 51 via a coupling pin 55 and operates in conjunction with the first lever 51 and the non-coupled state where the coupling via the coupling pin 55 is released and the second lever 52 operates independently of the first lever 51. Here, first, the coupled state will be described in detail, and the non-coupled state will be described together with a cancellation mechanism 100 to be described later.

The second lever 52 is formed with a through hole 105 that penetrates in the axial direction of the lever shaft 53 and through which the coupling pin 55 is inserted. The through hole 105 is divided into a coupling region 105A formed to be slightly larger than a diameter dimension of the coupling pin 55, and a non-coupling region 105B provided continuously from the coupling region 105A and larger than the coupling region 105A. When the coupling pin 55 is located in the coupling region 105A, the second lever 52 is in the coupled state, and when the coupling pin 55 is located in the non-coupling region 105B, the second lever 52 is in the non-coupled state. The coupling region 105A is provided at a position farther from the lever shaft 53 than the non-coupling region 105B, and is provided on a clockwise side in a rotation direction. The coupling portion 51b of the first lever 51 has a substantially U-shaped notch into which the coupling pin 55 can enter. In a case where the coupling pin 55 is located in the coupling region 105A, the coupling portion 51b rotates the second lever 52 in the release direction together with the coupling pin 55 when the first lever 51 rotates in the release direction (counterclockwise direction) around the lever shaft 53.

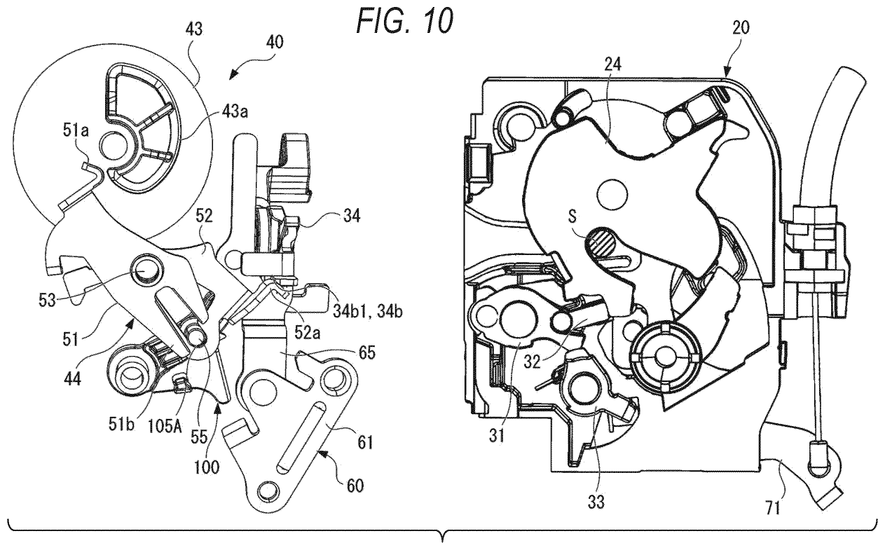

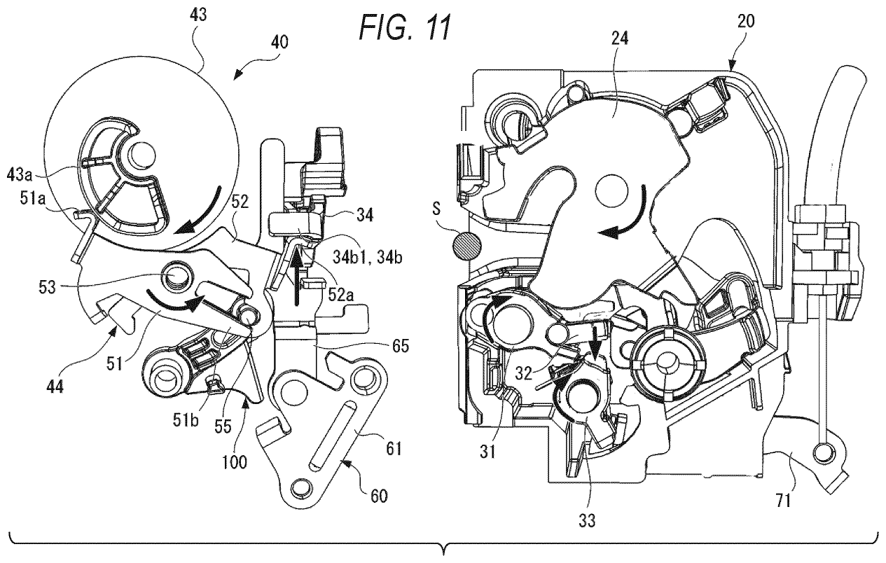

FIGS. 10 to 12 are diagrams illustrating an operation of the electric release mechanism 40 (left side in each figure) and an operation of the latch mechanism 20 (right side in each figure) when the opening operation of the door D is performed by the electric release mechanism 40. Thick arrows in FIGS. 11 and 12 indicate an operation direction of each element.

When the cam wheel 43 rotates forward from the standby position and the first lever 51 rotates in the release direction, the coupling portion 51b of the first lever 51 pushes up the coupling pin 55 and rotates the second lever 52 in the coupled state in the release direction. The operation portion 52a of the second lever 52 pushes up the first input portion 34b (electric side engagement portion 34b1) of the pawl lever 34. When the first input portion 34b is pushed up, as described above, the pawl 32 is in the non-abutment state of being separated from the latch 24, the latched state is released, and the door D is opened.

When the cam wheel 43 rotates reversely to return to the standby position after the door D is opened, the first lever 51 and the second lever 52 rotate in the standby direction around the lever shaft 53 by the biasing forces of the coil springs 51s and 52s, respectively, and return to the standby position. At this time, since the operation portion 52a of the second lever 52 moves downward, the push-up state of the first input portion 34b (electric side engagement portion 34b1) of the pawl lever 34 by the operation portion 52a is released. Therefore, the pawl 32 abuts against the outer peripheral surface of the latch 24 by the biasing force of the coil spring, and can be engaged with the latch 24 when the door Dis closed.

### [Manual Release Mechanism]

Returning to FIGS. 8 and 9, the manual release mechanism 60 includes the inner lever 61 that moves by manually operating the inner handle 3, a link member 65 that is coupled to the inner lever 61 and can be engaged with the pawl lever 34, and the outer lever 71 (see FIG. 7 and the like) that moves by manually operating the key cylinder 5 provided outside the vehicle cabin.

The inner lever 61 is disposed below and to the rear of the electric release mechanism 40. The inner lever 61 is supported by the housing 11 so as to be rotatable around a lever shaft 61a provided at an upper portion thereof. The inner lever 61 is biased in a direction toward the standby position (counterclockwise direction in FIG. 8) by a biasing force of a coil spring 61s provided in the housing 11.

The inner lever 61 includes an input portion 61b that is connected to the inner handle 3 via the cable 4 (see FIG. 3) and receives an input of the operation force from the inner handle 3, and a latch release portion 61c that transmits the operation force of the inner handle 3 to the pawl lever 34 via the link member 65 to cancel the latched state. The input portion 61b is provided at a lower end of the inner lever 61 and receives an input of the operation force of the inner handle 3. The latch release portion 61c is provided between the lever shaft 61a and the input portion 61b, and the link member 65 is connected to the latch release portion 61c.

The link member 65 extends in the up-down direction, and a lower end thereof is connected to the latch release portion 61c of the inner lever 61. The link member 65 includes an operation portion 66 that is engaged with the first input portion 34b (manual side engagement portion 34b2) of the pawl lever 34 to operate the pawl lever 34.

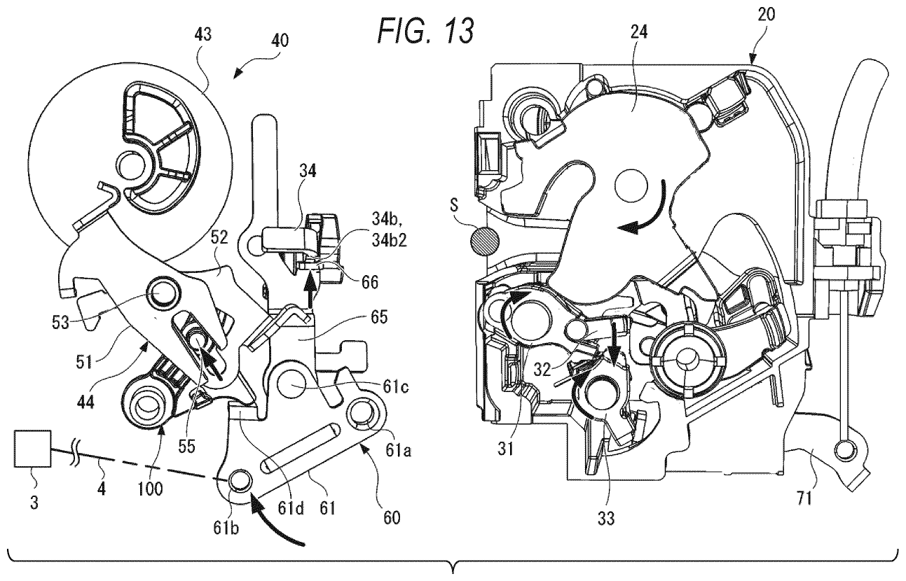

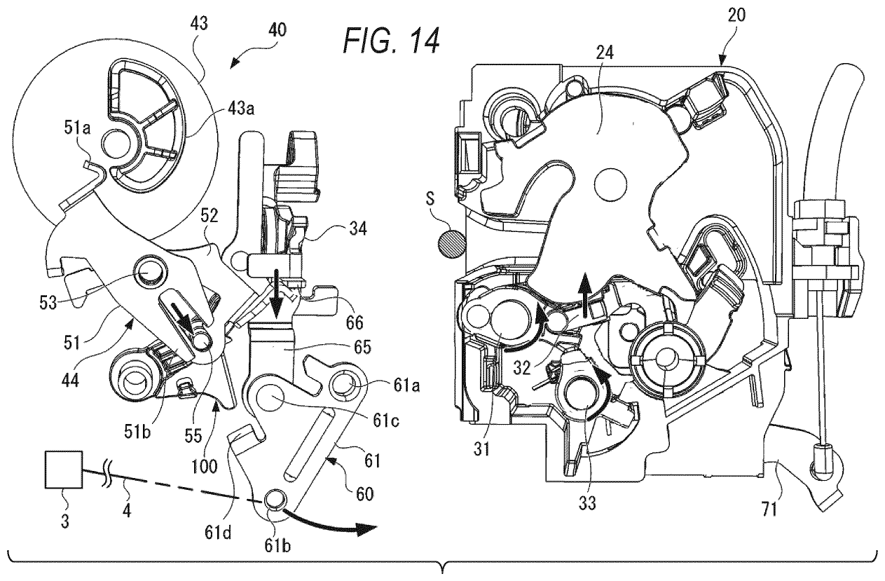

FIGS. 13 and 14 are diagrams illustrating an operation of the manual release mechanism 60 (left side in each figure) and an operation of the latch mechanism 20 (right side in each figure) when the opening operation of the door D is performed by the manual release mechanism 60. Thick arrows in FIGS. 13 and 14 indicate an operation direction of each element.

When the operation force of the inner handle 3 is input to the input portion 61b, the inner lever 61 rotates in the release direction (clockwise direction) around the lever shaft 61a against the biasing force of the coil spring 61s. The link member 65 moves upward in conjunction with the inner lever 61, and the operation portion 66 of the link member 65 is engaged with the first input portion 34b (manual side engagement portion 34b2) of the pawl lever 34 to push up the first input portion 34b. When the first input portion 34b is pushed up, as described above, the pawl 32 is in the non-abutment state of being separated from the latch 24, the latched state is released, and the door D is opened.

After the door D is opened, when the operation force of the inner handle 3 is released, the inner lever 61 returns to the standby position by the biasing force of the coil spring 61s. At this time, since the operation portion 66 of the link member 65 moves downward, the push-up state of the first input portion 34b (manual side engagement portion 34b2) of the pawl lever 34 by the operation portion 66 is released. Therefore, the pawl 32 abuts against the outer peripheral surface of the latch 24 by the biasing force of the coil spring, and can be engaged with the latch 24 when the door Dis closed.

Here, an operation of the coupling pin 55 when the latched state is canceled by the operation of the inner handle 3 will be described. When the inner lever 61 rotates in the release direction, a cancellation lever 101 also rotates in the counterclockwise direction to move the coupling pin 55. At this time, the coupling pin 55 temporarily moves from the coupling region 105A to the non-coupling region 105B. When the inner lever 61 returns to the standby position, the cancellation lever 101 also returns to the standby position in conjunction therewith, and the coupling pin 55 moves from the non-coupling region 105B to the coupling region 105A.

### [Cancellation Mechanism]

When the latched state is canceled by an operation of the electric release mechanism 40, as illustrated in FIG. 11, the operation portion 52a of the second lever 52 pushes up the first input portion 34b (electric side engagement portion 34b1) of the pawl lever 34. A position of each element of the electric release mechanism 40 in this state will also be referred to as an operation position in the following description. If the motor 41 is stuck (becomes unable to be driven) due to power shortage, failure, or the like when each element of the electric release mechanism 40 is in the operation position, a state where the pawl 32 does not abut against the latch 24 is maintained. When this state is maintained, even if the door D is moved in a closing direction, the latch 24 cannot be locked to the striker S (hereinafter, also referred to as a latch disabled state), and the door D cannot be closed.

Therefore, the door latch device 1 further includes the cancellation mechanism 100 that can be engaged with the inner lever 61 and cancels the latch disabled state by manually operating the inner handle 3 when the latch disabled state is maintained.

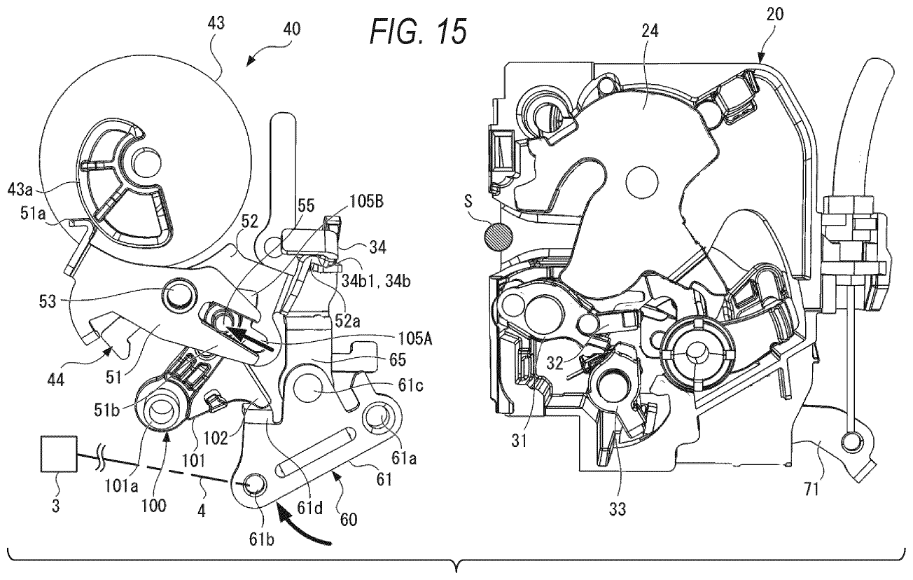

As illustrated in FIGS. 15 to 17, the cancellation mechanism 100 cancels the coupled state of the first lever 51 and the second lever 52 by the operation force of the inner handle 3 transmitted via the inner lever 61, thereby allowing the second lever 52 to retract from the operation position. As the second lever 52 retracts, the engagement between the operation portion 52a and the first input portion 34b (electric side engagement portion 34b1) of the pawl lever 34 is released, and the latch disabled state is released.

In this manner, the cancellation mechanism 100 cancels the latch disabled state by moving the second lever 52 stuck in the operation position, through manual operation of the inner handle 3. Therefore, even if the latch disabled state occurs due to power shortage, failure, or the like, the door D can be reliably closed by the manual operation from inside the vehicle cabin, the antitheft performance is improved, and the reliability of the door latch device 1 can be improved.

The cancellation mechanism 100 is provided independently of the motor 41. Specifically, since the cancellation mechanism 100 does not operate by driving the motor 41 but is provided independently of the motor 41 and the cam wheel 43, the cancellation mechanism 100 is not affected by the motor 41 when operated by the operation force of the inner handle 3. Therefore, even if each element of the electric release mechanism 40, including the motor 41, is stuck in the operation position, the cancellation mechanism 100 does not receive large frictional resistance caused by the sticking when operated by the operation force of the inner handle 3, and thus the latch disabled state can be released with good operability.

Next, a specific configuration of the cancellation mechanism 100 will be described in detail together with configurations of the inner lever 61 and the electric release lever 44.

As illustrated in FIGS. 8 and 9, the inner lever 61 further includes a cancel operation portion 61d that operates the cancellation mechanism 100 in addition to the latch release portion 61c described above. The cancel operation portion 61d is provided between the input portion 61b and the latch release portion 61c, and transmits the operation force of the inner handle 3 to the cancellation mechanism 100 to operate the cancellation mechanism 100. Since the inner lever 61 includes the latch release portion 61c and the cancel operation portion 61d, the release of the latched state and the operation of the cancellation mechanism 100 can be performed using the common inner lever 61. Therefore, in the door latch device 1, the number of components can be reduced.

The cancellation mechanism 100 includes the cancellation lever 101 that moves by being pressed against the cancel operation portion 61d of the inner lever 61. The cancellation lever 101 is provided between the inner lever 61 and the electric release lever 44. The cancellation lever 101 is rotatable around a lever shaft 101a provided below the electric release lever 44, and at least a part of the cancellation lever 101 overlaps the electric release lever 44 when viewed from an axial direction. The cancellation lever 101 is biased in the clockwise direction in FIG. 8 by a biasing force of a coil spring 101s provided in the housing 11.

The cancellation lever 101 can be engaged with the cancel operation portion 61d of the inner lever 61, and includes an input portion 102 that receives an input of the operation force of the inner handle 3 via the inner lever 61, and a pin holding portion 103 that holds the coupling pin 55. When the inner lever 61 rotates in the clockwise direction by the manual operation of the inner handle 3, the cancellation lever 101 moves by the input portion 102 being pressed against the cancel operation portion 61d of the inner lever 61, and rotates in the counterclockwise direction against the biasing force of the coil spring 101s.

The cancellation lever 101 does not normally move by driving the motor 41. Specifically, the pin holding portion 103 is formed with an elongated hole 103a that allows the coupling pin 55 to move. The elongated hole 103a is formed along a rotation direction of the first lever 51, and when the cancellation lever 101 is in the standby position, a movement trajectory of the coupling pin 55 by driving the motor 41 coincides with the elongated hole 103a. Therefore, even if the motor 41 is driven, only the coupling pin 55 moves in the elongated hole 103a, and the cancellation lever 101 does not operate.

The cancellation lever 101 moves the coupling pin 55 to cancel the coupled state of the second lever 52 and bring the second lever 52 into the non-coupled state, and allows the second lever 52 to retract from the operation position.

Referring to FIGS. 15 to 17, when the cancellation lever 101 is pressed against the inner lever 61 and moves, the coupling pin 55 moves from the coupling region 105A to the non-coupling region 105B formed in the second lever 52 (see FIG. 15). When the coupling pin 55 moves to the non-coupling region 105B, the second lever 52 is shifted to the non-coupled state where the second lever 52 is not interlocked with the first lever 51, and can operate independently of the first lever 51.

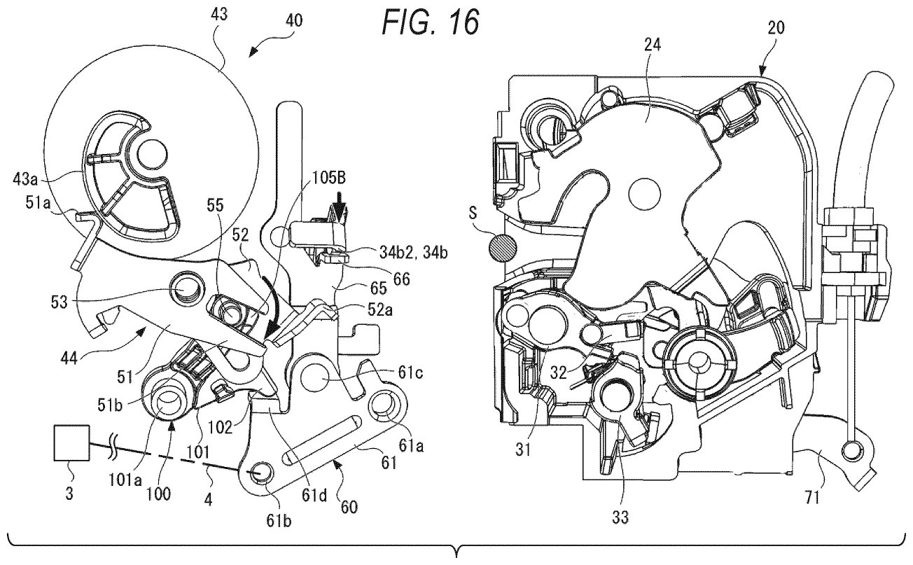

The second lever 52 rotates in the clockwise direction toward the standby position by the biasing force of the coil spring 52s, and the engagement between the operation portion 52a and the first input portion 34b (electric side engagement portion 34b1) of the pawl lever 34 is released (see FIG. 16). At this time, the operation portion 66 of the link member 65 moves upward from the standby position by the operation of the inner lever 61 and approaches the first input portion 34b (manual side engagement portion 34b2) of the pawl lever 34. Therefore, the manual side engagement portion 34b2 of the pawl lever 34 is received by the operation portion 66 of the link member 65 at a position close to the position where the engagement between the operation portion 52a and the electric side engagement portion 34b1 of the pawl lever 34 is released. As described above, even after the engagement with the operation portion 52a of the second lever 52 is released, the pawl lever 34 is prevented from rotating forcefully to the standby position, the impact applied to the pawl lever 34 can be prevented, and the generation of impact noise can be prevented.

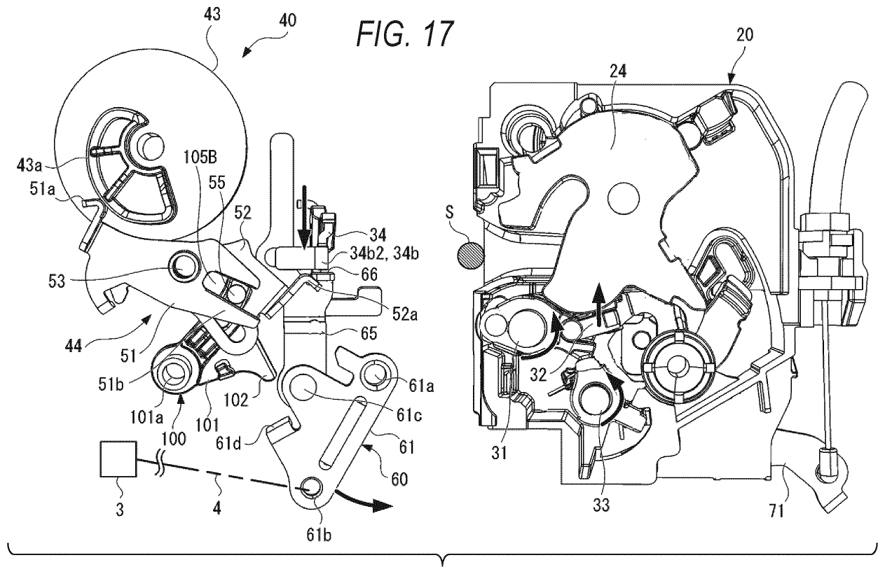

The first input portion 34b (manual side engagement portion 34b2) of the pawl lever 34 received by the operation portion 66 of the link member 65 moves downward and returns to the standby position as the inner lever 61 returns to the standby position by the operation of the inner handle 3 (see FIG. 17). Accordingly, the pawl 32 is shifted to a state of abutting against the latch 24, and the latch disabled state is released.

As described above, the cancellation mechanism 100 includes the cancellation lever 101, the coupling pin 55, and the through hole 105 formed in the second lever 52, and allows the second lever 52 to operate independently of the first lever 51 without the interlocking by the operation of the inner handle 3. Since the cancellation lever 101 can shift the first lever 51 and the second lever 52 from the coupled state to the non-coupled state only by moving the coupling pin 55, the latch disabled state can be reliably canceled with good operability. Since the coupling pin 55 is disposed within a projected area of the first lever 51 and the second lever 52, the cancellation mechanism 100 can be implemented that cancels the latch disabled state within a limited range in the housing 11, and the door latch device 1 can be simplified.

As described above, since the cancellation lever 101 includes the pin holding portion 103 that holds the coupling pin 55, the coupling pin 55 moves integrally with the cancellation lever 101 when the cancellation lever 101 is operated. Therefore, the responsiveness of the operation for canceling the latch disabled state is improved.

In the first input portion 34b of the pawl lever 34, the electric side engagement portion 34b1 with which the electric release mechanism 40 is engaged and the manual side engagement portion 34b2 with which the manual release mechanism 60 is engaged are provided at different positions. According to such a configuration, the electric release mechanism 40 does not affect a transmission path of the operation force of the inner handle 3 from the manual release mechanism 60 to the pawl lever 34. Therefore, even if the state where the motor 41 is not driven continues after the latch disabled state is canceled, the latched state can always be canceled by a manual operation from inside the vehicle cabin, and the reliability of the door latch device 1 can be improved.

Incidentally, the door latch device 1 described above does not include a lock mechanism that can disable the release of the latched state by the manual release mechanism 60. Since the lock mechanism is not provided, the number of components of the door latch device 1 can be reduced, and the door latch device 1 can be simplified.

In the door latch device 1 provided with no lock mechanism, it is necessary to ensure sufficient antitheft performance particularly for a manual operation from outside a vehicle. As described above, the operation of the outer lever 71 of the manual release mechanism 60 of the door latch device 1 requires a physical operation using the mechanical key 7. Therefore, the door latch device 1 can ensure sufficient antitheft performance even without a lock mechanism. Even if the electric release mechanism 40 does not operate due to a failure of the motor 41 or the like, the latched state can be canceled by a manual operation using the mechanical key 7 from outside the vehicle cabin, and thus the reliability of the door latch device 1 can be improved. As described above, according to the door latch device 1 of the present embodiment, the antitheft performance and the reliability can be ensured while simplifying the structure by providing no lock mechanism.

In the door latch device 1 of the present embodiment, the motor 41, the ECU 82, and the capacitor 83 are disposed at positions above the striker entering groove 27 and closer to the latch 24 than the pawl 32. The manual release mechanism 60 and the cancellation mechanism 100 are disposed at positions closer to the pawl 32 than the latch 24 at a position below the striker entering groove 27. Since the manual release mechanism 60 and the cancellation mechanism 100 are disposed at positions close to the pawl 32, the configuration for transmitting the operation force of the inner handle 3 to the pawl 32 can be simplified. Since the electrical components such as the motor 41, the ECU 82, and the capacitor 83 are disposed at positions close to the latch 24 disposed above the pawl 32, it is possible to prevent the electrical components from being exposed to liquids such as rainwater. As described above, since the arrangement of each element of the door latch device 1 is optimized, the door latch device 1 can be downsized.

Although an embodiment of the present disclosure has been described above with reference to the accompanying drawings, it is needless to say that the present invention is not limited to the embodiment. It is apparent to a person skilled in the art that various modifications or corrections can be conceived within the scope described in the claims, and it is understood that the modifications or corrections naturally fall within a technical scope of the present invention. Components in the above embodiments may be freely combined without departing from the gist of the disclosure.

The present specification describes at least the following matters. Corresponding components and the like in the embodiments described above are described in parentheses as an example, but the present invention is not limited thereto.

(1) A door latch device (door latch device 1) to be attached to a door (door D) of a vehicle (vehicle V), the door latch device including:
a latch mechanism (latch mechanism 20) that includes a latch (latch 24) configured to be engaged with a striker (striker S) provided on a vehicle body, and maintaining the door in a closed state with respect to the vehicle body by bringing the latch into a latched state where the latch is locked to the striker;
an electric release mechanism (electric release mechanism 40) configured to cancel the latched state by driving a motor (motor 41); and
a manual release mechanism (manual release mechanism 60) configured to cancel the latched state by a manual operation, in which
the electric release mechanism includes an electric release lever (electric release lever 44) operated by driving the motor,
the electric release lever includes:
   a first lever (first lever 51) operated by driving the motor; and
   a second lever (second lever 52) engaged with the latch mechanism in a coupled state of operating in conjunction with the first lever, to cancel the latched state,
the manual release mechanism includes an inner lever (inner lever 61) operated by manually operating a vehicle interior operation portion (inner handle 3) provided inside a vehicle cabin, and
the door latch device further includes:
   a cancellation mechanism (cancellation mechanism 100) provided independently of the motor, and canceling the coupled state between the first lever and the second lever by an operation force of the vehicle interior operation portion transmitted via the inner lever, to allow the second lever to retract from a predetermined position.

According to (1), since the door latch device includes the cancellation mechanism that is operated by the manual operation of the vehicle interior operation portion, even in a case where the motor becomes unable to be driven due to power shortage, failure, or the like and a latch disabled state is maintained, the latch disabled state can be canceled by manually operating the vehicle interior operation portion. Therefore, since the door can be reliably closed even in an emergency, the antitheft performance is improved, and the reliability of the door latch device is improved. Since the cancellation mechanism is provided independently of the motor, the cancellation mechanism can operate without being affected by the stuck motor, and the latch disabled state can be released with good operability.

(2) The door latch device according to (1), in which
the inner lever of the manual release mechanism includes:
   a latch release portion (latch release portion 61c) that transmits an operation force of the vehicle interior operation portion to the latch mechanism, to cancel the latched state, and
   a cancel operation portion (cancel operation portion 61d) that transmits an operation force of the vehicle interior operation portion to the cancellation mechanism, to operate the cancellation mechanism.

According to (2), since the inner lever includes the latch release portion that cancels the latched state and the cancel operation portion that operates the cancellation mechanism, the cancellation of the latched state and the operation of the cancellation mechanism can be performed using the common inner lever, and the number of components can be reduced.

(3) The door latch device according to (2), in which
the second lever of the electric release lever is capable of being shifted between the coupled state where the second lever is coupled to the first lever via a coupling pin (coupling pin 55) and operates in conjunction with the first lever, and a non-coupled state where the coupling via the coupling pin is released and the second lever is allowed to operate independently of the first lever,
the cancellation mechanism includes a cancellation lever (cancellation lever 101) operated by being pressed against the cancel operation portion of the inner lever, and
the cancellation lever moves the coupling pin to cancel the coupled state of the electric release lever and bring the electric release lever into the non-coupled state, and allows the second lever to retract from the predetermined position.

According to (3), since the cancellation lever can shift the first lever and the second lever from the coupled state to the non-coupled state by moving the coupling pin, the latch disabled state can be canceled with good operability. Since the coupling pin is disposed within a projected area of the first lever and the second lever, the cancellation mechanism can be implemented within a limited range, and the door latch device can be simplified.

(4) The door latch device according to (3), in which
the cancellation lever includes a pin holding portion (pin holding portion 103) that holds the coupling pin.

According to (4), since the cancellation lever holds the coupling pin, the coupling pin moves integrally with the cancellation lever when the cancellation lever is operated. Therefore, the responsiveness of the operation for canceling the latch disabled state is improved.

(5) The door latch device according to any one of (1) to (4), in which
the latch mechanism further includes
   a pawl (pawl 32) biased in a direction in which the pawl abuts against an outer peripheral surface of the latch, and configured to be engaged with the latch, and
   a pawl lever (pawl lever 34) configured to be engaged with the manual release mechanism and the electric release mechanism, and releasing an engagement of the pawl and the latch by the manual release mechanism or the electric release mechanism, and
the pawl lever has an engagement portion (manual side engagement portion 34b2) with the manual release mechanism and an engagement portion (electric side engagement portion 34b1) with the electric release mechanism, which are provided at different positions.

According to (5), since the pawl lever is provided with the engagement portion with the manual release mechanism and the engagement portion with the electric release mechanism at different positions, the electric release mechanism does not affect a transmission path of the operation force of the vehicle interior operation portion from the manual release mechanism to the pawl lever. Therefore, even if a state where the electric release mechanism does not operate due to power shortage or the like continues, the latched state can always be canceled by manual operation from inside a vehicle, and thus the reliability of the door latch device is improved.

(6) The door latch device according to (5), in which
the manual release mechanism further includes a link member (link member 65) coupled to the inner lever and configured to be engaged with the pawl lever,
the link member moves to approach the engagement portion of the pawl lever when the vehicle interior operation portion is manually operated, and
the link member receives the pawl lever disengaged from the second lever when the cancellation mechanism is operated by an operation force of the vehicle interior operation portion and the second lever is retracted from the predetermined position.

According to (6), when the latch disabled state is canceled, the link member moving to approach the pawl lever receives the pawl lever, and thus the pawl lever is prevented from rotating forcefully to the standby position, the impact applied to the pawl lever can be prevented, and the generation of impact noise can be prevented.

(7) The door latch device according to any one of (1) to (6), in which
the manual release mechanism further includes an outer lever (outer lever 71) operated by manually operating a vehicle exterior operation portion (key cylinder 5) provided outside the vehicle cabin using a tool (mechanical key 7), and
the outer lever moves by manually operating the vehicle exterior operation portion and is engaged with the latch mechanism to cancel the latched state.

When the door latch device is not provided with a lock mechanism and has a simple configuration, it is necessary to ensure sufficient antitheft performance for a manual operation from outside the vehicle cabin. According to (7), since the tool (for example, a mechanical key) is required to cancel the latched state by a manual operation from outside the vehicle cabin, the antitheft performance can be ensured even if the door latch device is not provided with a lock mechanism. Even if the electric release mechanism does not operate due to power shortage or the like, the latched state can be canceled by a manual operation using a tool from outside the vehicle cabin, and thus the reliability of the door latch device is improved. As described above, the antitheft performance and the reliability can be ensured while simplifying the door latch device by providing no lock mechanism.

(8) The door latch device according to any one of (1) to (7), further including:
a control device (ECU 82) configured to control the motor; and
a capacitor (capacitor 83) configured to storing power to be supplied to the motor and the control device, in which
the latch mechanism further includes a pawl (pawl 32) disposed below the latch and configured to be engaged with the latch,
the motor, the control device, and the capacitor are disposed at positions closer to the latch than the pawl, and
the manual release mechanism and the cancellation mechanism are disposed at positions closer to the pawl than the latch.

According to (8), since the manual release mechanism and the cancellation mechanism are disposed at positions close to the pawl, the configuration for transmitting the operation force of the vehicle interior operation portion to the pawl can be simplified. Since the electrical components such as the motor, the control device, and the capacitor are disposed at positions close to the latch disposed above the pawl, it is possible to prevent the electrical components from being exposed to liquids such as rainwater. As described above, since the arrangement of each element of the door latch device is optimized, the door latch device can be downsized.

What is claimed is:

1. A door latch device to be attached to a door of a vehicle, the door latch device comprising:
a latch mechanism including a latch configured to be engaged with a striker provided on a vehicle body, and maintaining the door in a closed state with respect to the vehicle body by bringing the latch into a latched state where the latch is locked to the striker;
an electric release mechanism configured to cancel the latched state by driving a motor; and
a manual release mechanism configured to cancel the latched state by a manual operation, wherein
the electric release mechanism includes an electric release lever operated by driving the motor,
the electric release lever includes:
a first lever operated by driving the motor; and
a second lever engaged with the latch mechanism in a coupled state of operating in conjunction with the first lever, to cancel the latched state,
the manual release mechanism includes an inner lever operated by manually operating a vehicle interior operation portion provided inside a vehicle cabin, and
the door latch device further comprises:
a cancellation mechanism provided independently of the motor, and canceling the coupled state between the first lever and the second lever by an operation force of the vehicle interior operation portion transmitted via the inner lever, to allow the second lever to retract from a predetermined position.

2. The door latch device according to claim 1, wherein
the inner lever of the manual release mechanism includes:
a latch release portion that transmits an operation force of the vehicle interior operation portion to the latch mechanism, to cancel the latched state; and
a cancel operation portion that transmits an operation force of the vehicle interior operation portion to the cancellation mechanism, to operate the cancellation mechanism.

3. The door latch device according to claim 2, wherein
the second lever of the electric release lever is configured to be shifted between the coupled state where the second lever is coupled to the first lever via a coupling pin and operates in conjunction with the first lever, and a non-coupled state where the coupling via the coupling pin is released and the second lever is allowed to operate independently of the first lever,
the cancellation mechanism includes a cancellation lever operated by being pressed against the cancel operation portion of the inner lever, and
the cancellation lever moves the coupling pin to cancel the coupled state of the electric release lever and bring the electric release lever into the non-coupled state, and allows the second lever to retract from the predetermined position.

4. The door latch device according to claim 3, wherein
the cancellation lever includes a pin holding portion that holds the coupling pin.

5. The door latch device according to claim 1, wherein
the latch mechanism further includes:
a pawl biased in a direction in which the pawl abuts against an outer peripheral surface of the latch, and configured to be engaged with the latch; and
a pawl lever configured to be engaged with the manual release mechanism and the electric release mechanism, and releasing an engagement of the pawl and the latch by the manual release mechanism or the electric release mechanism, and
the pawl lever has an engagement portion with the manual release mechanism and an engagement portion with the electric release mechanism, which are provided at different positions.

6. The door latch device according to claim 5, wherein
the manual release mechanism further includes a link member coupled to the inner lever and configured to be engaged with the pawl lever,
the link member moves to approach the engagement portion of the pawl lever when the vehicle interior operation portion is manually operated, and
the link member receives the pawl lever disengaged from the second lever when the cancellation mechanism is operated by an operation force of the vehicle interior operation portion and the second lever is retracted from the predetermined position.

7. The door latch device according to claim 1, wherein
the manual release mechanism further includes an outer lever operated by manually operating a vehicle exterior operation portion provided outside the vehicle cabin using a tool, and
the outer lever moves by manually operating the vehicle exterior operation portion, and is engaged with the latch mechanism to cancel the latched state.

8. The door latch device according to claim 1, further comprising:
a control device configured to control the motor; and
a capacitor storing power to be supplied to the motor and the control device, wherein
the latch mechanism further includes a pawl disposed below the latch and configured to be engaged with the latch,
the motor, the control device, and the capacitor are disposed at positions closer to the latch than the pawl, and
the manual release mechanism and the cancellation mechanism are disposed at positions closer to the pawl than the latch.
